(19) United States
(12) Patent Application Publication
(10) Pub. No.: US 2024/0267721 A1
(43) Pub. Date: Aug. 8, 2024

(54) ACCESS NETWORK APPARATUS, NETWORK SYSTEM, ORDER PROCESSING METHOD AND ORDER PROCESSING PROGRAM

(71) Applicant: Nippon Telegraph and Telephone Corporation, Tokyo (JP)

(72) Inventors: Shohei KODAMA, Musashino-shi, Tokyo (JP); Hiroshi Yoshida, Musashino-shi, Tokyo (JP); Nobuyuki CHIWATA, Musashino-shi, Tokyo (JP)

(21) Appl. No.: 18/568,144

(22) PCT Filed: Jun. 9, 2021
(86) PCT No.: PCT/JP2021/021958

§ 371 Date: Dec. 7, 2023

(51) Int. Cl. H04W 8/18; H04W 24/08

(52) U.S. Cl. CPC H04W 8/18; H04W 24/08

(57) ABSTRACT

An access network device according to an embodiment is an access network device that is disposed between a plurality of user-side terminals and a core network, provides the plurality of user-side terminals with connection to the core network, and includes an important user determination unit and an order processing unit. The important user determination unit acquires and accumulates user state information indicating a state of each user-side terminal, acquires user characteristic information indicating a characteristic of each user-side terminal from the accumulated past user state information, and determines an important user related to human life and/or safety on the basis of the acquired user characteristic information. The order processing unit preferentially processes a processing order related to the user-side terminal corresponding to the user determined to be an important user by the important user determination unit among a plurality of processing orders indicating a processing operation of the access network device related to each of the plurality of user-side terminals transmitted when a management device that manages the access network device returns from a non-operating state to an operating state.

### TECHNICAL FIELD

Embodiments of the invention relate to an access network device, a network system, an order processing method, and an order processing program.

### BACKGROUND ART

A business operator that provides a service for connecting to a core network such as the Internet or a telephone network to a user-side terminal of a user who is a subscriber includes an access network device connected to the core network and a plurality of user-side access network devices connected to the access network device. As described in Patent Literature 1, for example, the access network device can branch a signal from the core network into a plurality of user-side access network devices, and send a signal from each user-side access network device to the core network. At least one user-side terminal is physically or logically allocated and connected to each user-side access network device. Each user-side terminal is connected to the access network device through the user-side access network device, and is further allowed to connect to the core network through the access network device. That is, the access network device and the user-side access network device provide an access function for connecting the core network and the user-side terminal.

A management device called an element management system (EMS) is connected to the access network device. The EMS performs various management operations such as registration, setting, testing, information retrieval, and alarm monitoring on the access network device and the user-side access network device according to an order transmitted from a host system. For example, in a case where an order instructing to perform a setting related to a specific user-side terminal is given from the host system, the EMS can transmit a processing order for performing the setting instructed by the order to the access network device having the user-side terminal under its control. Upon receiving this processing order, the access network device can perform setting related to the corresponding user-side terminal in the access network device itself. Moreover, the access network device can perform setting related to the user-side access network device having the corresponding user-side terminal under its control. Alternatively, the access network device may transmit, to the user-side access network device, an instruction to perform setting related to the corresponding user-side terminal, and cause the user-side access network device to perform necessary setting.

Note that after the EMS comes to a non-operating state due to system maintenance or the like, when the maintenance or the like is completed and the EMS is restored to the operating state, a recovery operation is performed. In this recovery operation, orders distributed when the EMS is not in operation are retransmitted from the host system to the EMS by an administrator of the host system. The EMS transmits, to the access network device, a processing order for causing the access network device to perform a processing operation according to the retransmitted order. As a result, the access network device performs the processing operation according to the transmitted processing order.

### CITATION LIST

### Patent Literature

Patent Literature 1: JP 2015-056671 A

### SUMMARY OF INVENTION

### Technical Problem

Since a user such as a fire department, a police department, an emergency medical service, or a contact of other public or private socially important organization is an important user related to human life and/or safety, the access network device needs to preferentially process a processing order for a user-side access network device that connects a user-side terminal of such an important user.

However, since a large number of processing orders are distributed from the host system to the same access network device at the time of a recovery operation after system recovery, it may take time for the access network device to complete processing of a processing order even if the processing order is related to an important user that should be preferentially processed as described above.

An object of the invention is to provide a technique that enables priority processing of a processing order related to an important user at the time of a recovery operation.

### Solution to Problem

In order to solve the above problem, an access network device according to an aspect of the invention is an access network device that is disposed between a plurality of user-side terminals and a core network, provides the plurality of user-side terminals with connection to the core network, and includes an important user determination unit and an order processing unit. The important user determination unit acquires and accumulates user state information indicating a state of each user-side terminal, acquires user characteristic information indicating a characteristic of each user-side terminal from the accumulated past user state information, and determines an important user related to human life and/or safety on the basis of the acquired user characteristic information. The order processing unit preferentially processes a processing order related to the user-side terminal corresponding to the user determined to be an important user by the important user determination unit among a plurality of processing orders indicating a processing operation of the access network device related to each of the plurality of user-side terminals transmitted when a management device that manages the access network device returns from a non-operating state to an operating state.

### Advantageous Effects of Invention

According to one aspect of the invention, an access network device can provide a technique of determining an important user on the basis of past user state information accumulated for each user-side terminal, thereby enabling priority processing of a processing order related to the important user at the time of a recovery operation.

### BRIEF DESCRIPTION OF DRAWINGS

FIG. 1 is a schematic diagram illustrating a business network system including an access network device according to a first embodiment of the invention.

FIG. 2 is a block diagram illustrating an example of a functional configuration of the access network device according to the first embodiment.

FIG. 3 is a diagram illustrating an example of a hardware configuration of a computer in a case where the access network device according to the first embodiment is configured by a computer.

FIG. 4 is a diagram illustrating an example of a storage form of a user state information storage unit in FIG. 3.

FIG. 5 is a diagram illustrating another example of the storage form of the user state information storage unit.

FIG. 6 is a flowchart illustrating an example of an operation of the access network device.

FIG. 7 is a flowchart illustrating an example of an operation related to important user determination processing in an access network device according to a second embodiment of the invention.

FIG. 8 is a flowchart illustrating an example of an operation related to order queue registration processing in the second embodiment.

FIG. 9 is a flowchart illustrating an example of an operation related to queue transmission processing in the second embodiment.

### DESCRIPTION OF EMBODIMENTS

Hereinafter, embodiments according to the invention will be described with reference to the drawings.

### First Embodiment

### (Configuration)

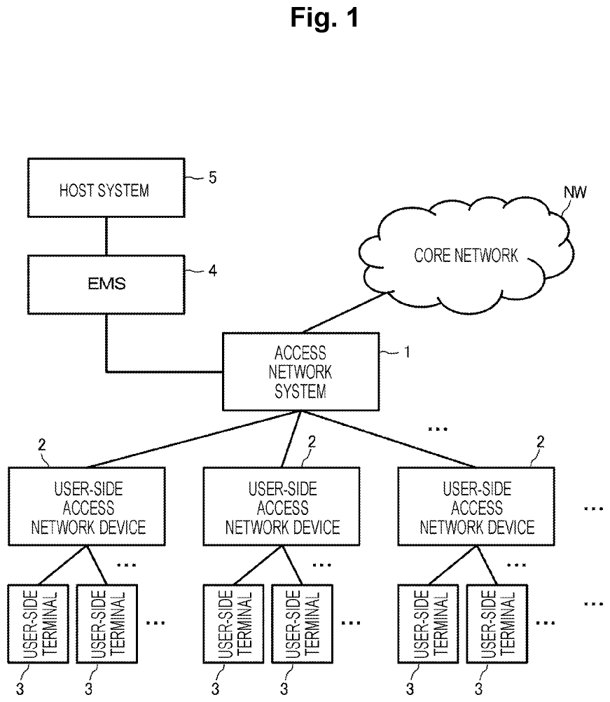

FIG. 1 is a schematic diagram illustrating a business network system including an access network device 1 according to a first embodiment of the invention.

The business network system is a network system deployed by a business operator that provides a service for connecting to a core network NW such as the Internet or a telephone network to a user who is a subscriber. In addition to the access network device 1, the business network system includes a plurality of user-side access network devices 2, a plurality of user-side terminals 3, an EMS 4, and a host system 5.

The access network device 1 is connected to the core network NW and the plurality of user-side access network devices 2, and provides each user-side access network device 2 with connection to the core network NW via the access network device 1.

Each user-side access network device 2 is connected to at least one user-side terminal 3, and provides each user-side terminal 3 with connection to the core network NW via the user-side access network device 2 and the access network device 1. That is, the access network device 1 and the user-side access network device 2 provide an access function for connecting the core network NW and the user-side terminal 3.

The user-side terminal 3 is a terminal owned by a user, and is used for voice communication and/or data communication via the core network NW by being connected to the user-side access network device 2. The user-side terminal 3 is, for example, a personal computer (PC), a smartphone, a telephone, or the like.

The EMS 4 performs management operations such as registration, setting, testing, information retrieval, and alarm monitoring on the access network device 1 and the user-side access network device 2 in order to enable the user-side terminal 3 to use communication via the core network NW.

The host system 5 is a system for an administrator who manages the business network system. By transmitting various orders to the EMS 4, the host system 5 can issue various operation instructions to the access network device 1 and the user-side access network device 2 via the EMS 4.

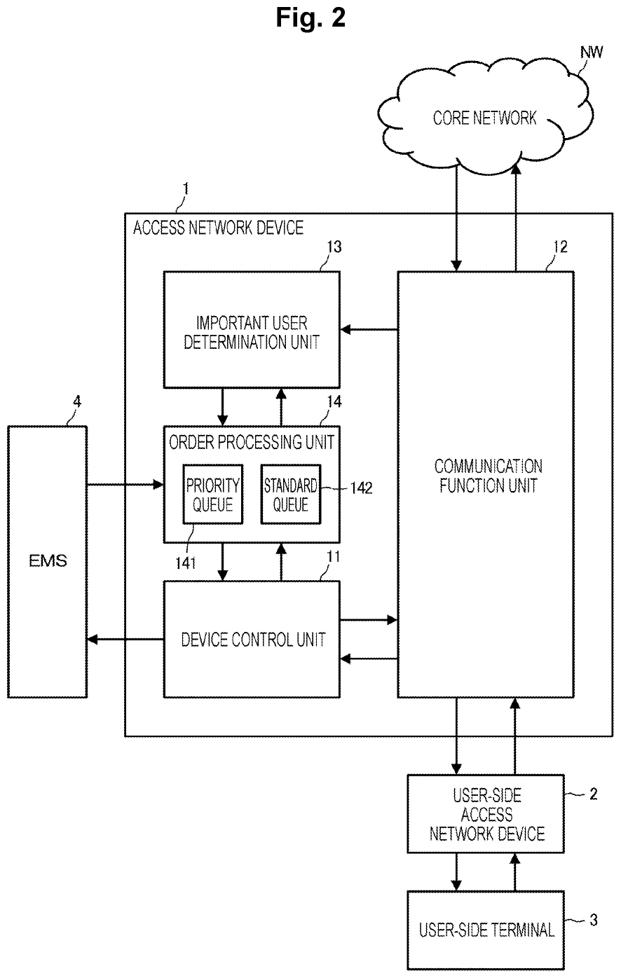

FIG. 2 is a block diagram illustrating an example of a functional configuration of the access network device 1 according to the first embodiment.

The access network device 1 includes a device control unit 11, a communication function unit 12, an important user determination unit 13, and an order processing unit 14.

The device control unit 11 controls each unit in the access network device 1, transmits control information to the user-side access network device 2 via the communication function unit 12, and controls an operation of the user-side access network device 2. Furthermore, the device control unit 11 transmits various types of information acquired from each unit in the access network device 1 and various types of information acquired from the user-side access network device 2 via the communication function unit 12 to the EMS 4.

The communication function unit 12 performs voice communication and/or data communication with the core network NW or with the user-side terminal 3 via the user-side access network device 2. Furthermore, the communication function unit 12 transmits user state information, which is information necessary for important user determination, such as time information, to the important user determination unit 13. The user state information is information indicating the state of the user-side terminal 3 including, for example, occurrence time information of a telephone call by the user-side terminal 3, power warning information issued by the user-side access network device 2 and indicating power-off of the user-side terminal 3, and the like.

Note that the occurrence time information of a telephone call can be acquired by the communication function unit 12, or can be acquired by the user-side access network device 2, and the communication function unit 12 can receive the occurrence time information issued by the user-side access network device 2 and transmit the occurrence time information to the important user determination unit 13.

Furthermore, the user-side access network device 2 can issue the power warning information, for example, by periodically transmitting an inquiry to the subordinate user-side terminal 3 and determining the state of the user-side terminal 3 according to the presence or absence of a reply. The communication function unit 12 can receive power warning information issued by the user-side access network device 2 and transmit the power warning information to the important user determination unit 13.

The important user determination unit 13 determines whether the user of each user-side terminal 3 is an important user on the basis of the user state information transmitted from each user-side access network device 2, and holds the determination result as important user information. Details of an important user determination method will be described later.

The order processing unit 14 holds a priority queue 141 and a standard queue 142 that store processing orders from the EMS 4. When receiving a processing order from the EMS 4, the order processing unit 14 inquires of the important user determination unit 13 whether the user to be processed is an important user. In response to this inquiry, the important user determination unit 13 returns a determination result indicating whether or not the user is an important user on the basis of the held important user information. According to the determination result from the important user determination unit 13, the order processing unit 14 stores the processing order from the EMS 4 in the priority queue 141 in the case of an important user, and stores the processing order from the EMS 4 in the standard queue 142 in the case of a non-important user. In the order processing unit 14, the processing order stored in the priority queue 141 is first transmitted to the device control unit 11 as device setting information. Therefore, the device control unit 11 preferentially processes the device setting information of the processing order related to an important user, and reflects the device setting information as control information of the access network device 1 and/or as the control information of the corresponding user-side access network device 2.

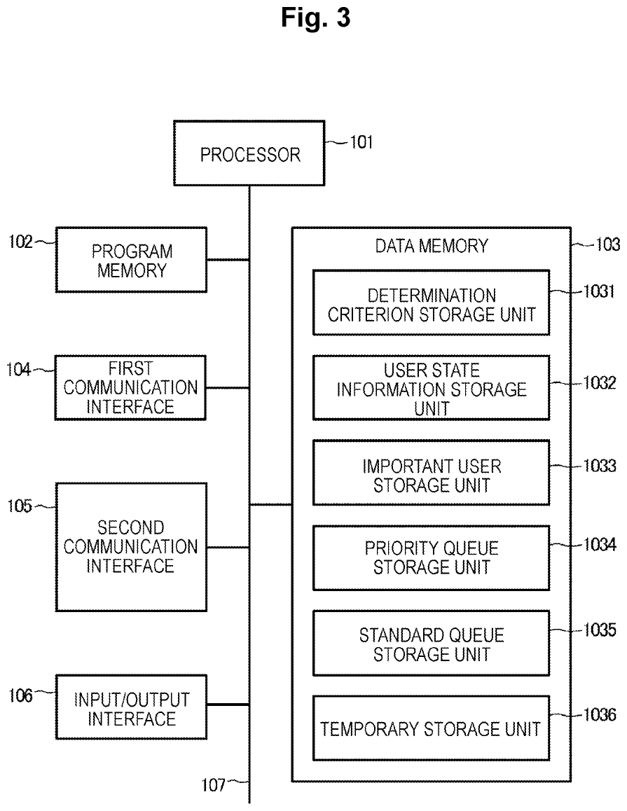

FIG. 3 is a diagram illustrating an example of a hardware configuration of a computer in a case where the access network device 1 according to the first embodiment is configured by a computer. The access network device 1 includes a hardware processor 101 such as a central processing unit (CPU). Then, in the access network device 1, a program memory 102, a data memory 103, a first communication interface 104, a second communication interface 105, and an input/output interface 106 are connected to the processor 101 via a bus 107. Note that the CPU can simultaneously execute a plurality of pieces of information processing by using a multi-core and multi-thread CPU. Further, the processor 101 may include a plurality of CPUs.

The program memory 102 is a non-transitory tangible computer readable storage medium in which a non-volatile memory capable of writing and reading data at any time, such as a hard disk drive (HDD) or a solid state drive (SSD), and a non-volatile memory such as a read only memory (ROM) are used in combination. The program memory 102 stores a control program necessary for the processor 101 to execute various types of control processing according to the present embodiment. For example, the important user determination unit 13 and the order processing unit 14 can be implemented by causing the processor 101 to read and execute an order processing program stored in the program memory 102. Note that some or all of these processing functional units may be implemented in other various forms including an integrated circuit such as an application specific integrated circuit (ASIC) or a field-programmable gate array (FPGA).

The data memory 103 is a tangible computer readable storage medium in which, for example, the above-described non-volatile memory and a volatile memory such as a random access memory (RAM) are used in combination. The data memory 103 is used to store various types of data acquired and created in the process of performing the various types of processing. For example, storage areas such as a determination criterion storage unit 1031, a user state information storage unit 1032, an important user storage unit 1033, a priority queue storage unit 1034, a standard queue storage unit 1035, and a temporary storage unit 1036 are secured in the data memory 103.

The determination criterion storage unit 1031 is a storage area for storing a determination criterion for determining whether or not the user of each user-side terminal 3 is an important user. In the present embodiment, an important user refers to a user related to human life and/or safety, such as a fire department, a police department, an emergency medical service, or a contact of another public or private socially important organization.

The user state information storage unit 1032 is a storage area for storing user state information transmitted from the user-side access network device 2.

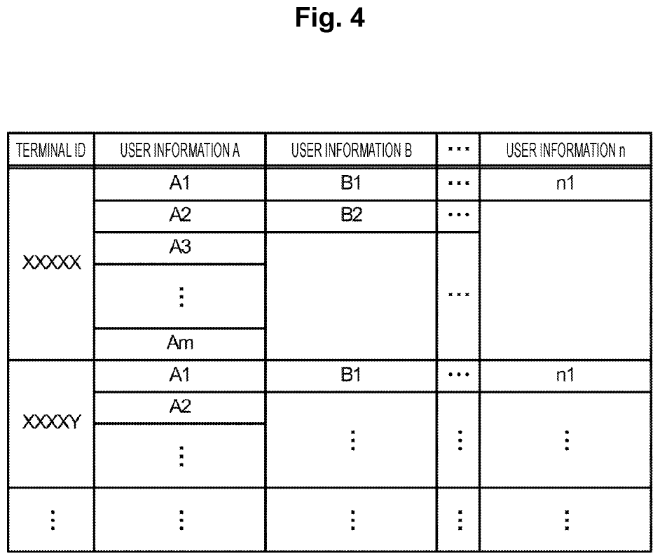

The user state information storage unit 1032 can store user state information for each user-side terminal 3. FIG. 4 is a diagram illustrating an example of a storage form of the user state information storage unit 1032. The user state information storage unit 1032 can accumulate user state information as state history information for each user by accumulating the user state information for each type for each terminal ID that identifies the user-side terminal 3. For example, in FIG. 4, user state information type A is start date and time information of an outgoing call of a telephone call by the user-side terminal 3, and A1, A2, . . . indicate different dates and times. The number of items to be accumulated may vary depending on the type of the user state information. For example, the start date and time information of outgoing calls of telephone calls may occur many times such as tens or hundreds of times per day in some cases, but the frequency of occurrence of power warning information indicating power-off of the user-side terminal 3 due to a power outage or a failure is extremely low such as once in several years. Therefore, the storage area to be secured may be different for each type of the user state information. When a situation occurs in which new information needs to be accumulated after the upper limit of the secured storage area is reached, the oldest information is discarded to secure the storage area. Alternatively, a storage period may be determined for each information type, and information that has passed the storage period may be periodically discarded.

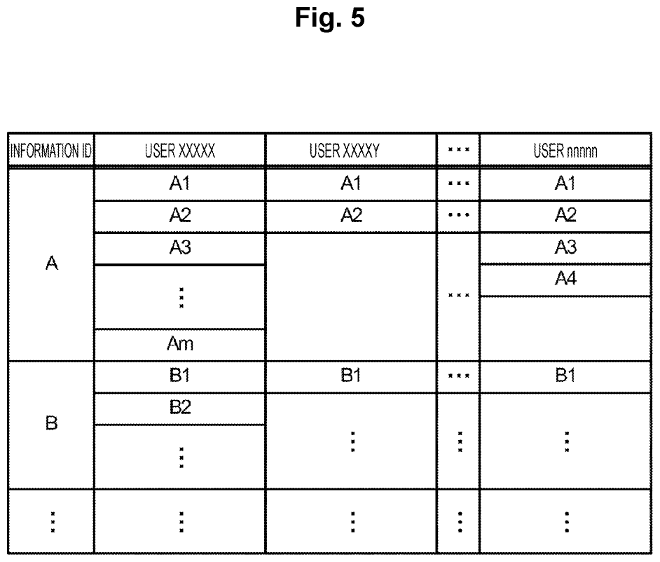

Furthermore, the user state information storage unit 1032 may store user state information for each type. FIG. 5 is a diagram illustrating another example of the storage form of the user state information storage unit 1032. The user state information storage unit 1032 can accumulate user state information as state history information for each user state information type by accumulating the user state information for each user-side terminal 3 for each information ID that identifies the type of the user state information. Discarding of the accumulated information in this case can also be performed in the same manner as described above.

Note that the form of accumulation of user state information may be any form other than the forms illustrated in FIGS. 4 and 5.

The important user storage unit 1033 is a storage area for storing identification information for identifying the user-side terminal 3 of a user determined to be an important user.

The priority queue storage unit 1034 is a storage area for storing a processing order from the EMS 4 as the priority queue 141.

The standard queue storage unit 1035 is a storage area for storing a processing order from the EMS 4 as the standard queue 142.

The temporary storage unit 1036 is a storage area for temporarily storing various types of data generated in the process in which the processor 101 executes various types of control processing.

The first communication interface 104 is a communication module for transmitting and receiving information to and from the EMS 4.

The second communication interface 105 is a communication module for performing voice communication and/or data communication between the core network NW and the user-side access network device 2 as the communication function unit 12.

The input/output interface 106 is an input/output module for connecting an input unit and a display unit as necessary. For example, a determination criterion to be stored in the determination criterion storage unit 1031 can be input via the input/output interface 106. The input criterion can also be input from the host system 5 through the EMS 4 via the first communication interface 104.

### (Operation)

Next, an operation of the access network device 1 according to the first embodiment will be described. Note that only the operation related to order control of processing orders from the EMS 4 will be described below, and the description of other operation parts similar to the operation of the conventional access network device will be omitted.

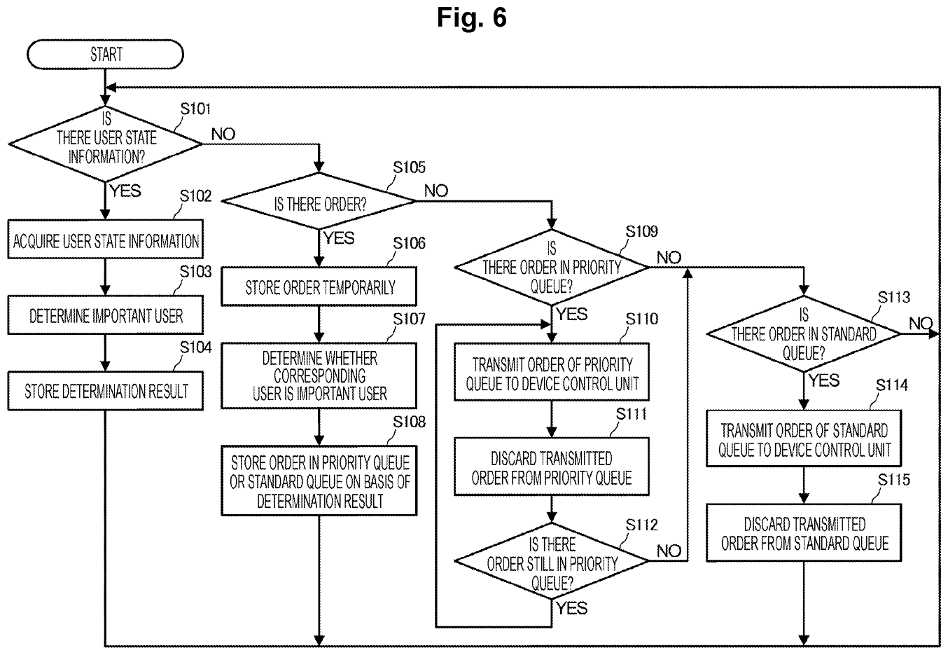

FIG. 6 is a flowchart illustrating an example of an operation of the access network device 1 according to the first embodiment. In a case where the access network device 1 is configured by a computer as illustrated in FIG. 3, an order processing program necessary for executing control processing illustrated in the flowchart is stored in the program memory 102, and the processor 101 can operate as the important user determination unit 13 and the order processing unit 14 of the access network device 1 as illustrated in FIG. 2 by executing the program.

Note that the determination criterion storage unit 1031 of the data memory 103 is assumed to already store the criterion input via the input/output interface 106 or the first communication interface 104.

The processor 101 of the access network device 1 first functions as the important user determination unit 13, and determines whether or not the second communication interface 105 serving as the communication function unit 12 has received user state information from the user-side access network device 2 (step S101).

When determining that user state information has been received (YES in step S101), the processor 101 acquires the user state information and stores the user state information in the user state information storage unit 1032 of the data memory 103 (step S102).

Then, the processor 101 acquires user characteristic information indicating the characteristic of the user-side terminal 3 from history information that is past user state information accumulated in the user state information storage unit 1032, and determines the important user on the basis of the acquired user characteristic information and a determination criterion stored in the determination criterion storage unit 1031 of the data memory 103 (step S103).

For example, assuming that the user state information is occurrence time information of a telephone call by the user-side terminal 3, the processor 101 can acquire, as user characteristic information,

(1) outgoing/incoming call ratio information indicating a ratio between outgoing and incoming calls in telephone calls by the user-side terminal 3, and

(2) call occurrence time information indicating an occurrence time of a telephone call by the user-side terminal 3.

Furthermore, assuming that the user state information is power warning information indicating power-off of the user-side terminal 3, the processor 101 can acquire, as user characteristic information,

(3) power warning issuance timing information indicating a power warning issuance timing of the user-side terminal 3 at the time of occurrence of a large-scale power outage or the like in which many pieces of power warning information are simultaneously issued, and

(4) maximum disconnection time information indicating a maximum value of a disconnection time indicated by a time during which the power warning is continuously issued, of the user-side terminal 3.

In telephone communication of an important user, there are more incoming calls than outgoing calls, and communication occurs regardless of the time zone or day or night. Therefore, the important user determination unit 13 can determine that a user of the user-side terminal 3 whose number of incoming calls is determined to be large in past calls regardless of day or night is an important user on the basis of the (1) outgoing/incoming call ratio information and the (2) call occurrence time information described above, that is, call traffic. The determination criterion storage unit 1031 stores, as a determination criterion, a threshold of the incoming/outgoing call ratio for determining whether the number of incoming calls is large or small and start and end times of the night time.

Furthermore, there is a high possibility that an emergency power supply is installed in equipment on the important user side including the user-side terminal 3. Therefore, when power-off of a plurality of user-side terminals 3 occurs simultaneously due to a large-scale power outage or the like, the user-side access network device 2 issues a power warning for the user-side terminal 3 of an important user at a timing later than that of the other user-side access network devices 2. Therefore, the important user determination unit 13 can determine that a user of the user-side terminal 3 whose power warning issuance timing at the time of occurrence of a large-scale power outage or the like in the past is determined to be later than that of the other user-side terminals 3 is an important user on the basis of the (3) power warning issuance timing information described above. The determination criterion storage unit 1031 stores a threshold of the difference between power warning issuance timings as a determination criterion.

Moreover, when a failure occurs in the user-side terminal 3 or the user-side access network device 2, repair is preferentially performed for the user-side terminal 3 or the user-side access network device 2 related to an important user. Therefore, the important user determination unit 13 can determine that a user of the user-side terminal 3 whose past failure recovery time is determined to be shorter than that of the other user-side terminals 3 is an important user on the basis of the (4) maximum disconnection time information described above. The determination criterion storage unit 1031 stores the threshold of the maximum disconnection time as a determination criterion.

The processor 101 stores identification information indicating the user-side terminal 3 of the user determined to be an important user in the important user storage unit 1033 of the data memory 103 as important user information (step S104). Thereafter, the processor 101 proceeds to the processing of step S101.

Meanwhile, when determining in step S101 that user state information has not been received (NO in step S101), the processor 101 functions as the order processing unit 14 and determines whether or not the first communication interface 104 has received a processing order from the EMS 4 (step S105).

When determining that the processing order has been received (YES in step S105), the processor 101 temporarily stores the received processing order in the temporary storage unit 1036 of the data memory 103 (step S106).

Then, the processor 101 determines whether or not a user of the user-side terminal 3 related to the processing order is an important user (step S107). Whether or not the user is an important user can be determined by whether or not the identification information indicating the user-side terminal 3 related to the processing order is stored in the important user storage unit 1033 as important user information.

The processor 101 stores the processing order in the priority queue 141 or the standard queue 142 on the basis of the determination result (step S108). That is, the processor 101 stores the processing order in the priority queue storage unit 1034 when determining that the user is an important user, and stores the processing order in the standard queue storage unit 1035 when determining that the user is not an important user. Thereafter, the processor 101 proceeds to the processing of step S101.

Meanwhile, when determining in step S105 that a processing order is not received (NO in step S105), the processor 101 determines whether or not a processing order is stored in the priority queue 141 (step S109).

When determining that a processing order is stored in the priority queue 141 (YES in step S109), the processor 101 transmits device setting information based on the oldest processing order among the processing orders stored in the priority queue 141 to the device control unit 11 (step S110). Then, the processor 101 discards the processing order from the priority queue 141 (step S111).

Thereafter, the processor 101 determines whether or not there is still a processing order stored in the priority queue 141 (step S112). When determining that there is still a processing order stored in the priority queue 141 (YES in step S112), the processor 101 proceeds to the processing of step S110. In this way, the processing order stored in the priority queue 141 can be processed preferentially. Then, when determining in step S112 that processing of all the processing orders stored in the priority queue 141 is finished and there is no more processing order stored (NO in step S112), the processor 101 proceeds to the processing of step S113 described later.

When determining in step S109 that there is no processing order stored in the priority queue 141 (NO in step S109), or when determining in step S112 that there is no more processing order stored in the priority queue 141 (NO in step S112), the processor 101 determines whether or not a processing order is stored in the standard queue 142 (step S113). When determining that there is no processing order stored in the standard queue 142 (NO in step S113), the processor 101 proceeds to the processing of step S101.

On the other hand, when determining that a processing order is stored in the standard queue 142 (YES in step S113), the processor 101 transmits device setting information based on the oldest processing order among the processing orders stored in the standard queue 142 to the device control unit 11 (step S114). Then, the processor 101 discards the processing order from the standard queue 142 (step S115).

Thereafter, the processor 101 proceeds to the processing of step S101. Note that even if there is still a processing order stored in the standard queue 142, since the processing order is not a processing order related to an important user, there is not much problem when the processing proceeds through steps S101, S105, and S109 and waits until the determination of the processing order storage for the standard queue 142 in step S113 is made again. If all the processing orders stored in the standard queue 142 are processed similarly to the priority queue 141, a processing order transmitted from the EMS 4 to an important user during the processing cannot be processed preferentially. Therefore, the standard queue 142 is excluded from the processing target, that is, the processing is suspended every time one processing order is processed. As described above, in the present embodiment, a processing order for an important user can be preferentially processed in a reliable manner.

In the first embodiment as described above, the access network device 1 that is disposed between the plurality of user-side terminals 3 and the core network NW and provides the plurality of user-side terminals 3 with connection to the core network NW includes: the important user determination unit 13 that acquires and accumulates user state information indicating a state of each user-side terminal 3, acquires user characteristic information indicating a characteristic of each user-side terminal 3 from the accumulated past user state information, and determines an important user related to human life and/or safety on the basis of the acquired user characteristic information; and the order processing unit 14 that preferentially processes, that is, causes the device control unit 11 to preferentially process, a processing order related to the user-side terminal 3 corresponding to a user determined to be an important user by the important user determination unit 13 among a plurality of processing orders indicating a processing operation of the access network device 1 related to each of the plurality of user-side terminals 3 transmitted when the EMS 4 serving as a management device managing the access network device 1 returns from a non-operating state to an operating state. As a result, the access network device 1 according to the first embodiment can provide a technique of determining an important user on the basis of past user state information accumulated for each user-side terminal 3, thereby enabling priority processing of a processing order related to the important user at the time of a recovery operation. Accordingly, processing time of a processing order to the access network device 1 accommodating the user-side terminal 3 of an important user such as the fire department, the police, and the emergency medical service is shortened, and the quality of important public services can be improved.

Note that the access network device 1 provides the plurality of user-side terminals 3 with connection to the core network NW via the plurality of user-side access network devices 2 to which at least one user-side terminal 3 is connected, the important user determination unit 13 acquires user state information of the plurality of user-side terminals 3 via the plurality of user-side access network devices 2, and a plurality of processing orders transmitted from the EMS 4 can also include a processing order indicating a processing operation of the user-side access network device 2 related to the user-side terminal 3. Therefore, the access network device 1 can also perform priority processing of a processing order related to an important user for the user-side access network device 2.

Then, the order processing unit 14 includes the priority queue 141 that stores a processing order related to the user-side terminal 3 corresponding to a user determined to be an important user by the important user determination unit 13 and the standard queue 142 that stores a processing order related to the user-side terminal 3 corresponding to a user not determined to be an important user by the important user determination unit 13, and suspends processing of a processing order stored in the standard queue 142 until processing of the processing order stored in the priority queue 141 is completed. Therefore, the access network device 1 can reliably perform priority processing on a processing order to be preferentially processed by storing a processing order to be preferentially processed and other processing orders in different queues.

Note that user state information includes occurrence time information of a telephone call by the user-side terminal 3, and the important user determination unit 13 acquires, as user characteristic information, outgoing/incoming call ratio information indicating a ratio between outgoing and incoming calls in telephone calls by the user-side terminal 3 and call occurrence time information indicating an occurrence time of a telephone call by the user-side terminal 3 on the basis of the occurrence time information, and determines that a user of the user-side terminal 3 whose number of incoming calls is determined to be large in past calls regardless of day or night is an important user on the basis of the outgoing/incoming call ratio information and the call occurrence time information. In this way, the access network device 1 can easily determine whether or not a user is an important user on the basis of occurrence time information of telephone calls by the user-side terminal 3.

Furthermore, user state information includes power warning information indicating power-off of the user-side terminal 3, and the important user determination unit 13 can acquire, as user characteristic information, power warning issuance timing information indicating a power warning issuance timing of the user-side terminal 3 on the basis of the power warning information, and determine, on the basis of the power warning issuance timing information, that a user of the user-side terminal 3 whose power warning issuance timing is later than that of the other user-side terminals 3 is an important user among a plurality of user-side terminals 3 for which power warning has been simultaneously issued in the past. Moreover, the important user determination unit 13 can acquire, as user characteristic information, maximum disconnection time information indicating the maximum value of a disconnection time indicated by a time during which the power warning information is continuously issued of the user-side terminal 3 on the basis of the power warning information, and determine, on the basis of the maximum disconnection time information, that a user of the user-side terminal whose past failure recovery time is shorter than that of the other user-side terminals is an important user. As described above, the access network device 1 can easily determine whether or not a user is an important user on the basis of power warning information indicating power-off of the user-side terminal 3.

### Second Embodiment

An access network device 1 according to a second embodiment of the invention is similar to that of the first embodiment. The present embodiment is an example of a case where a processor 101 is capable of executing a plurality of pieces of information processing at the same time, such as a multi-task CPU.

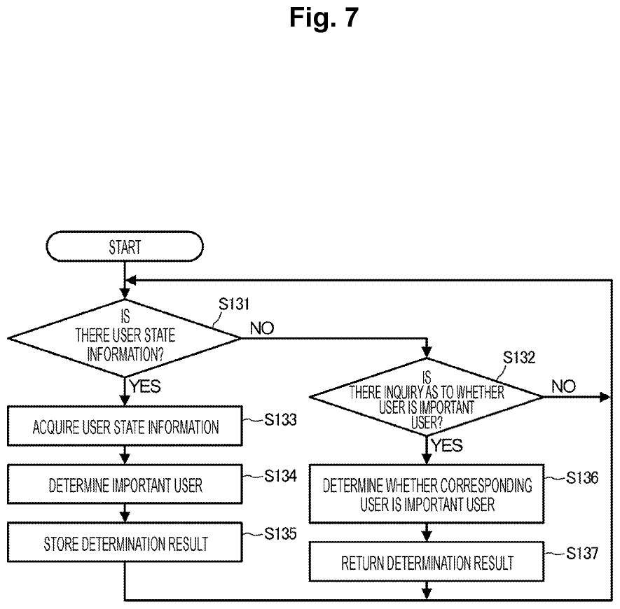

In this case, the processor 101 can perform parallel processing by decomposing a series of processing as illustrated in the flowchart of FIG. 6 in the first embodiment into a plurality of processing groups. For example, in a program memory 102, an order processing program is decomposed and stored as programs necessary for executing each of control processing as illustrated in flowcharts of FIGS. 7 to 9. CPU threads of the processor 101 execute the programs in parallel, so that the processor 101 can operate as an important user determination unit 13 or an order processing unit 14.

FIG. 7 is a flowchart illustrating an example of an operation related to processing of the important user determination unit 13.

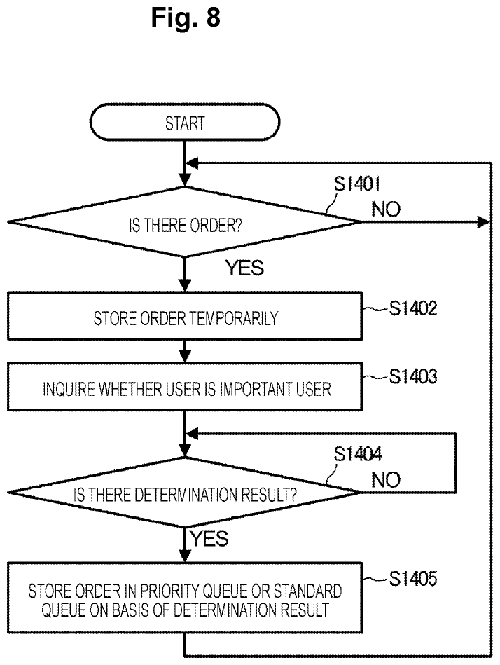

The processor 101 of the access network device 1 determines whether or not a second communication interface 105 serving as a communication function unit 12 has received user state information from a user-side access network device 2 (step S131). This processing corresponds to the processing of step S101 in the first embodiment. When determining that user state information has not been received (NO in step S131), the processor 101 further determines whether or not there has been an inquiry as to whether the user is an important user from the CPU thread executing an operation related to order queue registration processing of the order processing unit 14 illustrated in the flowchart of FIG. 8 (step S132). When determining that no inquiry has been made (NO in step S132), the processor 101 proceeds to the processing of step S131.

When determining in step S131 that the user state information has been received (YES in step S131), the processor 101 acquires the user state information and stores the user state information in a user state information storage unit 1032 of a data memory 103 (step S133). This processing corresponds to the processing of step S102 in the first embodiment.

Then, the processor 101 determines the important user on the basis of user characteristic information obtained from past user state information accumulated in the user state information storage unit 1032 and a determination criterion stored in a determination criterion storage unit 1031 of the data memory 103 (step S134). This processing corresponds to the processing of step S103 in the first embodiment.

The processor 101 stores identification information indicating a user-side terminal 3 of the user determined to be an important user in an important user storage unit 1033 of the data memory 103 as important user information (step S135). This processing corresponds to the processing of step S104 in the first embodiment. Thereafter, the processor 101 proceeds to the processing of step S131.

FIG. 8 is a flowchart illustrating an example of an operation related to the order queue registration processing in the order processing unit 14.

The processor 101 determines whether or not a first communication interface 104 has received a processing order from an EMS 4 (step S1401). This processing corresponds to the processing of step S105 in the first embodiment. When determining that a processing order has not been received (NO in step S1401), the processor 101 repeats the processing in step S1401.

When determining that a processing order has been received (YES in step S1401), the processor 101 temporarily stores the received processing order in a temporary storage unit 1036 of the data memory 103 (step S1402). This processing corresponds to the processing of step S106 in the first embodiment.

Then, the processor 101 inquires of a CPU thread executing an operation related to the important user determination processing of the important user determination unit 13 illustrated in the flowchart of FIG. 7 whether or not a user of the user-side terminal 3 related to the processing order is an important user (step S1403). This inquiry can include identification information indicating the user-side terminal 3 related to the processing order.

When the CPU thread executing the operation related to the important user determination processing receives a target of inquiry as to whether the user is an important user, the CPU thread determines that there has been an inquiry as to whether the user is an important user in step S132 of FIG. 7 (YES in step S132). In this case, the processor 101 determines whether the user corresponding to identification information indicating the user-side terminal 3 related to the processing order included in the inquiry is an important user (step S136). Whether or not the user is an important user can be determined by whether or not the identification information is stored in the important user storage unit 1033 as important user information. The processor 101 returns the determination result to the inquiry source CPU thread (step S137). Then, the processor 101 proceeds to the processing of step S131.

Returning to the description of FIG. 8, after making the inquiry in step S1403, the processor 101 determines whether or not a determination result has been returned from the corresponding CPU thread (step S1404). When determining that no determination result has been returned (NO in step S1404), the processor 101 repeats the processing of step S1404. In this way, the processor 101 waits until for a determination result to be returned.

When determining that a determination result has been returned (YES in step S1404), the processor 101 stores the processing order in the priority queue storage unit 1034 which is the priority queue 141 or the standard queue 142 which is the standard queue storage unit 1035 on the basis of the determination result (step S1405). That is, the processing in steps S1403 and S1404 and the processing in steps S132, S136, and S137 in FIG. 7 correspond to the processing in step S107 in the first embodiment, and the processing in step S1405 corresponds to the processing in step S108 in the first embodiment. Thereafter, the processor 101 proceeds to the processing of step S1401.

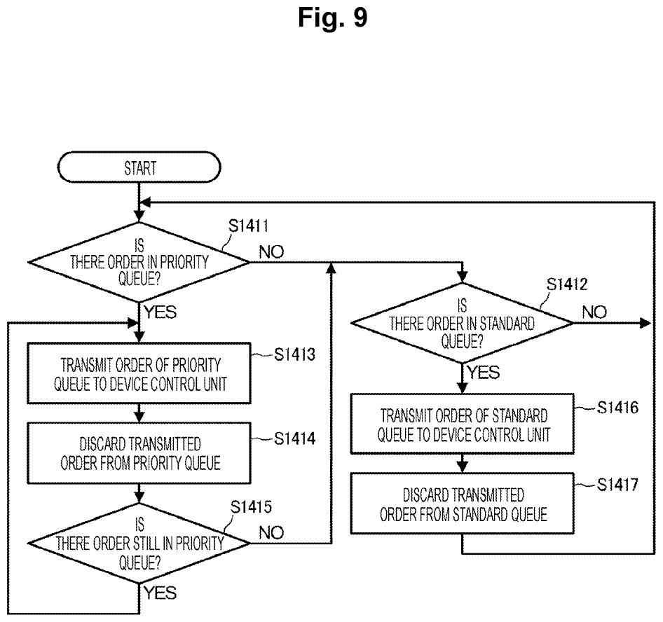

FIG. 9 is a flowchart illustrating an example of an operation related to queue transmission processing in the order processing unit 14.

The processor 101 determines whether or not a processing order is stored in the priority queue 141 (step S1411). This processing corresponds to the processing of step S109 in the first embodiment. When determining that there is no processing order stored in the priority queue 141 (NO in step S1411), the processor 101 further determines whether or not a processing order is stored in the standard queue 142 (step S1412). This processing corresponds to the processing of step S113 in the first embodiment. When determining that there is no processing order stored in the standard queue 142 (NO in step S1412), the processor 101 proceeds to the processing of step S1411.

When determining in step S1411 that a processing order is stored in the priority queue 141 (YES in step S1411), the processor 101 transmits device setting information based on the oldest processing order among the processing orders stored in the priority queue 141 to the device control unit 11 (step S1413). This processing corresponds to the processing of step S110 in the first embodiment. Then, the processor 101 discards the processing order from the priority queue 141 (step S1414). This processing corresponds to the processing of step S111 in the first embodiment.

Thereafter, the processor 101 determines whether or not there is still a processing order stored in the priority queue 141 (step S1415). This processing corresponds to the processing of step S112 in the first embodiment. When determining that there is still a processing order stored in the priority queue 141 (YES in step S1415), the processor 101 proceeds to the processing of step S1413. Then, in step S1415, when determining that there is no more processing order stored (NO in step S1415), the processor 101 proceeds to the processing of step S1412.

When determining in step S1412 that a processing order is stored in the standard queue 142 (YES in step S1412), the processor 101 transmits device setting information based on the oldest processing order among the processing orders stored in the standard queue 142 to the device control unit 11 (step S1416). This processing corresponds to the processing of step S114 in the first embodiment. Then, the processor 101 discards the processing order from the standard queue 142 (step S1417). This processing corresponds to the processing of step S115 in the first embodiment. Thereafter, the processor 101 proceeds to the processing of step S1411.

As described above, in the second embodiment, too, the same functions and effects as those of the first embodiment can be obtained.

### Other Embodiments

In the above embodiment, regarding the user characteristic information, (1) outgoing/incoming call ratio information, (2) call occurrence time information, (3) power warning issuance timing information, and (4) maximum disconnection time information are taken as examples, and all important users determined on the basis of any one of them are assumed to be important users. However, important users may be narrowed down to users determined to be important users on the basis of a plurality of determination results. Furthermore, priority or weighting may be performed on the user characteristic information and the important user determination result based on the user characteristic information to narrow down the important users. Note that it is a matter of course that the user characteristic information is not limited to the information of (1) to (4) described above.

Further, while the above embodiment describes the configuration in which the business network system connects the user-side terminal 3 to the access network device 1 via the user-side access network device 2 as an example, a network system without the user-side access network device 2 may be used. That is, the access network device 1 may directly connect a plurality of user-side terminals 3.

Furthermore, the method described in each embodiment can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as an order processing program (software means) that can be executed by a computing machine (computer), and can also be distributed by being transmitted through a communication medium. Note that the program stored on the medium side also includes a setting program for configuring, in the computing machine, software means (including not only execution program but also tables and data structures) to be executed by the computing machine. The computing machine that implements the present device executes the above-described processing by reading the programs recorded in the recording medium, constructing the software means by a setting program as needed, and controlling the operation by the software means. Note that the recording medium described in the present specification is not limited to a recording medium for distribution, but includes a storage medium such as a magnetic disk or a semiconductor memory provided in the computing machine or in a device connected via a network.

In short, the invention is not limited to the aforementioned embodiments, and various modifications can be made in the implementation stage without departing from the gist thereof. Furthermore, the embodiments may be implemented in appropriate combinations if possible, and in such cases, combined effects can be obtained. Moreover, the aforementioned embodiments include inventions at various stages, and various inventions can be extracted by appropriate combinations of a plurality of disclosed components.

### REFERENCE SIGNS LIST

1 Access network device
2 User-side access network device
3 User-side terminal
4 EMS
5 Host system
11 Device control unit
12 Communication function unit
13 Important user determination unit
14 Order processing unit
141 Priority queue
142 Standard queue
101 Processor
102 Program memory
103 Data memory
1031 Determination criterion storage unit
1032 User state information storage unit
1033 Important user storage unit
1034 Priority queue storage unit
1035 Standard queue storage unit
1036 Temporary storage unit
104 First communication interface
105 Second communication interface
106 Input/output interface
107 Bus
NW Core network

1. An access network device that is disposed between a plurality of user-side terminals and a core network and provides the plurality of user-side terminals with connection to the core network, the access network device comprising
an important user determination unit, including one or more processors, configured to:
acquire and accumulate user state information indicating a state of each user-side terminal;
acquire user characteristic information indicating a characteristic of each user-side terminal from the accumulated past user state information; and
determine an important user related to human life and/or safety on a basis of the acquired user characteristic information; and
an order processing unit, including one or more processors, configured to preferentially process a processing order related to the user-side terminal corresponding to a user determined to be an important user by the important user determination unit among a plurality of processing orders indicating a processing operation of the access network device related to each of the plurality of user-side terminals transmitted when a management device managing the access network device returns from a non-operating state to an operating state.

2. The access network device according to claim 1, wherein:
the access network device is configured to provide the plurality of user-side terminals with connection to the core network via a plurality of user-side access network devices to which at least one user-side terminal is connected; and
the important user determination unit is configured to acquire user state information of the plurality of user-side terminals via the plurality of user-side access network devices,
wherein the plurality of processing orders transmitted from the management device also include a processing order indicating a processing operation of the user-side access network device related to the user-side terminal.

3. The access network device according to claim 2, wherein
the order processing unit is configured to:
include a priority queue that stores the processing order related to the user-side terminal corresponding to a user determined to be an important user by the important user determination unit and a standard queue that stores the processing order related to the user-side terminal corresponding to a user not determined to be an important user by the important user determination unit; and
suspend processing of the processing order stored in the standard queue until processing of the processing order stored in the priority queue is completed.

4. The access network device according to claim 3, wherein
the user state information includes occurrence time information of a telephone call by the user-side terminal, and
the important user determination unit is configured to:
acquire, as the user characteristic information, outgoing/incoming call ratio information indicating a ratio between outgoing and incoming calls in the telephone call by the user-side terminal and call occurrence time information indicating an occurrence time of a telephone call by the user-side terminal on the basis of the occurrence time information; and
determine that a user of a user-side terminal whose number of incoming calls is determined to be large in past calls regardless of day or night is the important user on the basis of the outgoing/incoming call ratio information and the call occurrence time information.

5. The access network device according to claim 4, wherein
the user state information includes power warning information indicating power-off of the user-side terminal, and
the important user determination unit is configured to:
acquire, as the user characteristic information, power warning issuance timing information indicating a power warning issuance timing of the user-side terminal and maximum disconnection time information indicating a maximum value of a disconnection time indicated by a time during which the power warning information is continuously issued of the user-side terminal on the basis of the power warning information;
determine, on the basis of the power warning issuance timing information, that a user of a user-side terminal whose power warning issuance timing is later than that of other user-side terminals is an important user among a plurality of user-side terminals for which power warning has been simultaneously issued previously; and
determine, on the basis of the maximum disconnection time information, that a user of a user-side terminal whose past failure recovery time is shorter than that of other user-side terminals is the important user.

6. A network system comprising an access network device that provides a plurality of user-side terminals with connection to a core network, a management device that manages the access network device, and a host system that issues an operation instruction to the access network device via the management device, wherein:
when the management device returns from a non-operating state to an operating state, the host system retransmits a plurality of operation instructions that had been transmitted to the management device during the non-operating state of the management device;
the management device transmits a plurality of processing orders indicating processing operations of the access network device related to each of the plurality of user-side terminals to the access network device according to the retransmitted plurality of operation instructions from the host system; and
the access network device comprises:
an important user determination unit, including one or more processors, configured to:
acquire and accumulate user state information indicating a state of each user-side terminal;
acquire user characteristic information indicating a characteristic of each user-side terminal from the accumulated past user state information; and
determine an important user related to human life and/or safety on a basis of the acquired user characteristic information; and
an order processing unit, including one or more processors, configured to preferentially process a processing order related to the user-side terminal corresponding to the user determined to be an important user by the important user determination unit among the plurality of processing orders transmitted from the management device.

7. An order processing method in an access network device that includes a processor and a memory, that is disposed between a plurality of user-side terminals and a core network, and that provides the plurality of user-side terminals with connection to the core network, the order processing method comprising:
acquiring user state information indicating a state of each user-side terminal and storing the user state information in the memory by the processor;
acquiring user characteristic information indicating a characteristic of each user-side terminal from past user state information accumulated in the memory and determining an important user related to human life and/or safety on a basis of the acquired user characteristic information by the processor; and
preferentially processing, by the processor, a processing order related to the user-side terminal corresponding to the user determined to be an important user among a plurality of processing orders indicating a processing operation of the access network device related to each of the plurality of user-side terminals transmitted when a management device managing the access network device returns from a non-operating state to an operating state.

8. An order processing program causing a processor to function as the important user determination unit and the order processing unit of the access network device according to claim 1.
